(19) United States
(12) Patent Application Publication
(10) Pub. No.: US 2015/0296372 A1
(43) Pub. Date: Oct. 15, 2015

(54) METHOD AND SYSTEM FOR THE REMOTELY QUERYING VEHICLE DATA

(71) Applicant: Robert Bosch GmbH, Stuttgart (DE)

(72) Inventors: Felix Hieronymi, Moeglingen (DE); Rolf Nicodemus, Bietigheim-Bissingen (DE); Walter Lehle, Leinfelden (DE); Stefan Schneider, Moensheim (DE); Jean-Luc Augier, Asperg (DE)

(21) Appl. No.: 14/441,777

(22) PCT Filed: Oct. 7, 2013
(86) PCT No.: PCT/EP2013/070828

§ 371 Date: May 8, 2015

(30) Foreign Application Priority Data
Nov. 23, 2012 (DE) 10 2012 221 462.3

(51) Int. Cl. H04W 8/24; H04L 29/08

(52) U.S. Cl. CPC H04W 8/24; H04L 67/12

(57) ABSTRACT

A method for querying vehicle data, e.g., data related to the odometer reading and/or wear of the vehicle, includes the following steps: a) transmitting a vehicle identifier from a user terminal to a server; b) establishing a wireless data link between the server and the vehicle identified by the vehicle identifier; c) transmitting data from the control unit of the vehicle to the server; d) analyzing the transmitted data; and e) transmitting the data and/or the analysis results to the user terminal.

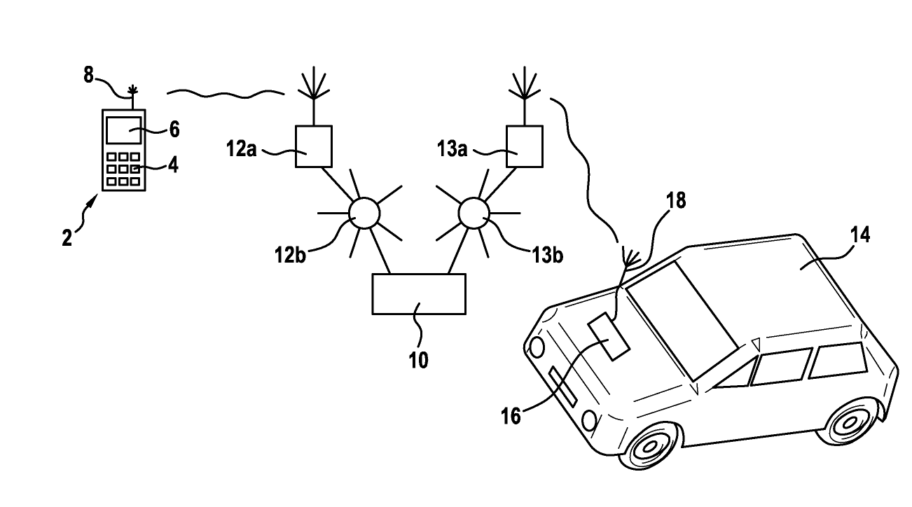

### BACKGROUND OF THE INVENTION

1. Field of the Invention

The present invention relates to a method and a system for remotely querying vehicle data, especially data of a motor vehicle.

2. Description of the Related Art

It frequently happens that odometer readings and other features (service intervals, accident frequency, etc.), which are related to the mileage, are manipulated in used vehicles. Such manipulations are undertaken in particular with the intent to defraud in order to obtain a higher price when selling used cars to private customers.

It is an object of this invention to provide a simple opportunity for uncovering such manipulations.

### BRIEF SUMMARY OF THE INVENTION

The method of the present invention for querying vehicle data includes the following steps:
Transmitting a vehicle identifier from a user terminal to a server;
Establishing a wireless data link between the server and a vehicle identified by the vehicle identifier;
Transmitting data from the vehicle to the server; and
Transmitting data from the vehicle to the user terminal.

The data in particular may be diagnostic data from an (engine) control unit of the vehicle. Preferably, the transmitted data in particular are data from which the mileage and/or the wear of the vehicle are/is able to be inferred and which have a bearing on the value of the vehicle, such as the current odometer reading, the number of starting operations, actuations of the clutch and/or the brake, etc.

The data and/or analysis results are displayed on the user terminal and can thus be compared with the information provided by the seller, so that possible manipulations and fraud attempts are able to be uncovered.

The present invention also encompasses a server for querying vehicle data, which is set up
to establish a wireless connection to a control unit of a vehicle;
read out data from the control unit via the wireless connection;
possibly select, evaluate and/or analyze the read out data; and
transmit the read out data and/or the analysis results to a user terminal.

The present invention moreover encompasses a control unit for a motor vehicle, which is set up to transmit data via a wireless network.

The invention also includes a system for querying vehicle data using a server according to the invention and a control unit according to the invention.

The mobile user terminal may be a mobile user terminal, especially a cell phone, e.g., a smartphone, or a tablet PC.

In one specific embodiment, the data received from the vehicle are forwarded to the user terminal without modifications. As an alternative or in addition, the data received from the vehicle may be selected, evaluated and/or analyzed and the results of this selection, evaluation or analysis be transmitted to the user terminal. If only the results are transmitted to the user terminal, then the data quantity to be transmitted from the server to the user terminal can be reduced.

In one specific embodiment of the method, the steps of establishing a wireless connection for the data transmission between the server and the vehicle identified by the vehicle identification, and the transmission of data from the control unit of the vehicle to the server are carried out at regular time intervals and/or whenever predefined criteria are met, such as a certain odometer reading. This makes it possible to reduce the delays during the data querying by the user terminal, because there is no need to wait until a data link between the server and the control unit in the vehicle has been established and the data have been transmitted from the control unit to the server.

By querying and storing data at regular intervals across the entire service life of the vehicle, it is furthermore possible to uncover manipulations of the vehicle data, especially the odometer reading, in a simple and reliable manner.

In one specific embodiment of the method, the steps of establishing a wireless connection for the data transmission between the server and the vehicle identified by the vehicle identifier, and the transmission of data from the control unit of the vehicle to the server are carried out only, or also, if data is requested by the user terminal. This makes it possible to transmit the current data from the control unit to the user terminal at any time. In addition, unnecessary data transmissions between the control unit and the user terminal are avoided when no data are required over a longer period of time.

In one specific embodiment of the present invention, the transmitted data and/or the analysis results are checked for plausibility prior to being transmitted to the user terminal, so that errors in the data transmission are detected and the output of incorrect and/or nonsensical data or results that might confuse the user or could induce incorrect conclusions are avoided.

The data can also be transmitted in encrypted form in order to reliably prevent unauthorized access to the data.

In one specific embodiment, the server is developed to establish the wireless connection to the control unit via a mobile telephony network, a local area network, and/or the Internet. A server developed in this manner makes it possible to always establish the connection via the network that is available in the particular situation and is best suited for the task. A data transmission in particular via the Internet allows worldwide data links to be set up in a cost-effective manner.

The present invention will now be explained in detail in the following text, with reference to the attached drawing.

### BRIEF DESCRIPTION OF THE DRAWING

The FIGURE shows a schematic view of a system for querying vehicle data according to the present invention.

### DETAILED DESCRIPTION OF THE INVENTION

Such a system includes a mobile user terminal 2, which is equipped with a data input device 4, especially a keyboard, and a display device 6. Data input device 4 and display device 6 may also be developed in combination, in the form of a touch-sensitive monitor (touchscreen). Mobile user terminal 2 could be a mobile telephone, especially a smartphone.

User terminal 2 encompasses a data communications device (not shown in the figure) having an antenna 8, which enables user terminal 2 to communicate via a first network 12b, especially a mobile telephony network or a wireless local area network (WLAN).

Antenna 8 of user terminal 2 is shown outside of user terminal 2 for reasons of greater clarity. Of course, antenna 8 may also be situated inside user terminal 2.

Mobile user terminal 2 communicates via antenna 8 with base station 12a of first network 12b, which is connected to a central server 10 in a wireless or a wire-bound manner. First network 12b thereby provides a data link between mobile user terminal 2 and central server 10.

In addition, the system includes a motor vehicle 14 having a control unit 16; control unit 16 is likewise equipped with a transceiver (not shown in the figure) and an antenna 18, which enables control unit 16 to communicate with server 10 in a wireless manner via a base station 13a of a second network 13b, especially a mobile telephony network or WLAN.

In contrast to the illustration in the figure, antenna 18 of control unit 16 may also be disposed inside motor vehicle 14 and, in particular, inside control unit 16.

The communication of control unit 16 with central server 10 may take place via the same network 13b as the communication of server 10 with user terminal 2. First network 12b and second network 13b are identical in this case. However, the communication may also take place via two or more different networks 12b, 13b.

To query vehicle data through user terminal 2, an unambiguous vehicle identifier, e.g., a vehicle identification number (VIN), is transmitted from user terminal 2 via first network 12b to server 10.

Via second network 13b, server 10 establishes a data link with control unit 16 of motor vehicle 14, which has been identified by the vehicle identifier, and causes data, especially diagnostic data, to be transmitted via second network 13b from control unit 16 to server 10.

The transmission of data from control unit 16 to server 10 may take place at specified time intervals or at specified odometer readings of motor vehicle 14 across the entire service life of motor vehicle 14.

In this way server 10 always has relatively current data available and is able to immediately transmit these data to user terminal 2 upon request, without the need to first establish a data link between server 10 and control unit 16 of motor vehicle 14. Delays when user terminal 2 is querying the data are reduced or avoided in this manner. Querying and storing data at regular intervals across the entire service life of motor vehicle 14 also makes it possible to uncover manipulations of the odometer reading, for instance, in a reliable manner.

As an alternative or in addition, the transmission of data from control unit 16 to server 10 may be started whenever a data query by a user terminal 2 is taking place. This makes it possible to always transmit the most current data from control unit 16 to user terminal 2. If a data transmission from control unit 16 to server 10 is triggered only when a request from user terminal 2 is at hand, loading of second network 13b by unnecessary data transmissions, as well as the related costs, are able to be avoided. This is advantageous in particular when the data from control unit 16 are queried only infrequently.

The data transmitted from control unit 16 via network 13b to server 10 may be transmitted to control unit 2 in unchanged form via network 12b for the display there on display device 6.

As an alternative or in addition, the data transmitted from control unit 16 are able to be processed, especially selected, analyzed and/or evaluated in server 10, and the results of the data processing are transmittable to user terminal 2 via first network 12b and displayed on display device 6. If only the results are transmitted to user terminal 2, the data quantity to be transmitted via first network 12b is able to be reduced by such data processing in server 10. This lowers the loading of first network 12b, which is especially advantageous if the costs of using first network 12b are linked to the transmitted data volume. Moreover, the speed of the data transmission can be increased and delays reduced in this manner.

The analysis of the transmitted data may alternatively or additionally also take place in user terminal 2.

The data may be transmitted in encrypted form in an effort to avoid fraudulent use.

In addition, the system may be set up in such a way that a data transmission between user terminal 2 and server 10 or between server 10 and control unit 16 of motor vehicle 14 is possible only after user terminal 2 or its user has identified itself vis-à-vis server 10 and/or server 10 has in turn identified itself vis-à-vis control unit 16. The identification may take place by transmitting an encrypted access code, for instance, and/or by inputting a password or a personal identification number (PIN).

If user terminal 2 is a mobile telephone, especially a smartphone, an application (“app”) may be installed on user terminal 2, which allows the vehicle data to be queried from control unit 16 according to the present invention in a simple and comfortable manner. If required, different applications may be made available, which have different functionality scopes and/or different rights to the data query in each case. For example, an authorized service facility or service personnel may thereby be able to query more data than a mere user.

According to the present invention, the vehicle data may be queried and evaluated by a potential purchaser of motor vehicle 14 or it may be queried for such a person, in order to uncover possible manipulations of the odometer reading or other modifications of motor vehicle 14, for example.

In conjunction with a GPS receiver connected to control unit 16, a system according to the present invention can also transmit current positional data of motor vehicle 14, so that an uncomplicated recovery of a lost, especially stolen, motor vehicle 14 is possible.

Networks 12b, 13b may be mobile telephony networks, the Internet, and/or a local, at least partially wireless, area network (WLAN), e.g., on company property.

1-10. (canceled)

11. A method for querying vehicle data, comprising:
a) transmitting a vehicle identifier from a user terminal to a server;
b) establishing a wireless data link between the server and a vehicle identified by the vehicle identifier;
c) transmitting data from the vehicle to the server, wherein the transmitted data include at least one of (i) data related to odometer reading and (ii) data related to wear of the vehicle; and
d) transmitting data from the server to the user terminal.

12. The method as recited in claim 11, wherein the steps b) and c) are carried out at least one of (i) at regular time intervals and (ii) after the user terminal has requested data.

13. The method as recited in claim 11, wherein the data transmitted from the vehicle to the server are processed in the server, the processing including at least one of selecting, evaluating and analyzing in the server, and wherein results of the data processing are transmitted from the server to the user terminal.

14. The method as recited in claim 13, wherein at least one of (i) the data transmitted from the vehicle to the server, and (ii) the results of the data processing in the server are checked for plausibility prior to being transmitted to the user terminal.

15. A server for querying vehicle data, comprising:
a processor configured to:
a) receive a vehicle identifier from a user terminal;
b) establish a wireless collection to a control unit of a vehicle identified by the vehicle identifier;
c) read out data from the control unit via the wireless connection, wherein the read-out data include at least one of (i) data related to odometer reading and (ii) data related to wear of the vehicle;
d) process the read-out data; and
e) transmit at least one of the read-out data and results of the processing to the user terminal.

16. The server as recited in claim 15, wherein the server is configured to establish the wireless connection to the vehicle via at least one of a mobile telephone network, a local wireless network and the Internet.

17. The server as recited in claim 16, wherein the server is configured to at least one of (i) carry out the steps c) and d) at regular time intervals and (ii) carry out the steps c) and d) when data is requested by the user terminal.

18. A system for querying vehicle data, comprising:
a user terminal configured to transmit a vehicle identifier and receive data; and
a server configured to:
a) receive the vehicle identifier from the user terminal
b) establish a wireless connection to a control unit of a vehicle identified by the vehicle identifier;
c) read-out data from the control unit via the wireless connection, wherein the read-out data include at least one of (i) data related to odometer reading and (ii) data related to wear of the vehicle;
d) process the read-out, data; and
e) transmit at least one of the read-out data and results of the processing to the processing to the user terminal.

19. The system as recited in claim 18, further comprising:
the control unit of the vehicle, wherein the control unit is configured to transmit at least one of (i) data related to odometer reading and (ii) data related to wear of the vehicle.

20. The system as recited in claim 18, wherein the user terminal is a mobile phone.
